(19) United States
(12) Patent Application Publication
(10) Pub. No.: US 2018/0266825 A1
(43) Pub. Date: Sep. 20, 2018

(54) METHOD FOR ESTIMATING THE BIAS OF A SENSOR

(71) Applicant: Commissariat a l'energie atomique et aux energies, Paris (FR)

(72) Inventor: Christophe VILLIEN, Seyssinet-Pariset (FR)

(73) Assignee: Commissariat a l'energie atomique et aux energies, Paris (FR)

(21) Appl. No.: 15/926,365

(22) Filed: Mar. 20, 2018

(30) Foreign Application Priority Data
Mar. 20, 2017 (FR) 17 52268

(51) Int. Cl. G01C 19/5776; G01C 21/16; G01P 15/18; G01P 15/16; G01P 21/00

(52) U.S. Cl. CPC G01C 19/5776; G01C 21/16; G01P 21/00; G01P 15/16; G01P 15/18

(57) ABSTRACT

The invention is a method for estimating and updating the bias of a sensor. After an initialization phase, the method includes the following steps:
acquiring a signal (sₖ) at a measurement time (tₖ), there corresponding to each measurement time a bias (mₖ) determined in a preceding iteration or during the initialization and a dispersion threshold (v_{th,k}) determined in a preceding iteration or during the initialization;
associating an analysis time period (Δtₖ) with the measurement time (tₖ), and calculating a dispersion indicator (vₖ) representing a dispersion of the signals acquired over the analysis time period;
comparing the dispersion indicator thus calculated with the dispersion threshold (v_{th,k}) used in the first step;
depending on the comparison, either keeping the bias at an unchanged value or updating the bias;
subtracting the bias (mₖ) resulting from the preceding step from the signal (sₖ) acquired at the measurement time; and
incrementing the measurement time (tₖ) and reiterating the steps listed above.
   When the bias is updated, the dispersion threshold is also updated depending on the dispersion indicator (vₖ) calculated at the measurement time.

### FIELD OF THE INVENTION

The technical field of the invention relates to movement sensors of the gyrometer or accelerometer type. The objective of the invention is to process the signals generated by these sensors while taking into account a bias, in order to obtain more precise measurements.

### BACKGROUND

Movement sensors have undergone considerable development, in particular because of their use in portable devices and especially connected portable devices. These sensors generate a signal, at various measurement times, depending on their movement at said measurement times. Among these sensors, mention may for example be made of gyrometers, which allow an angular velocity of rotation to be obtained for one or more angles of rotation. On the basis of this velocity, angles of rotation of the sensor may be estimated.

It is known that the signals generated by this type of sensor may be affected by a bias. This bias may for example be caused by a sensor imperfection of electrical or mechanical origin. In the case of a gyrometer, the bias may for example result from a variation in the temperature or humidity of the environment in which the sensor is placed, or be due to a variation in a supply current used to power the sensor. This bias may vary over time. For this reason it must be estimated frequently, so as to take into account the variation of the bias as a function of time and allow measurements that are precise enough to be obtained.

Methods have been developed with the aim of estimating bias so as to allow it to be taken into account. A first solution is based on comparison of information generated by various types of sensors. Document US 2011/0178707 for example describes estimating a bias affecting the measurements of a gyrometer by estimating an angular velocity using a magnetometer and an accelerometer. The angular velocity thus estimated is compared to the angular velocity delivered by the gyrometer. This comparison allows the bias affecting the values measured by the gyrometer to be determined. Such a method however assumes the presence of sensors of various types and requires complex computational operations.

A second solution is based on determining times that are propitious for determining bias. For example, document EP0496172 describes estimating the bias of a gyrometer of the navigation system of a vehicle. The bias of the gyrometer is evaluated when the vehicle is not moving.

This approach is also followed in US20110172820, this document describing a method for correcting a gyrometer integrated into a robot. The bias of the gyrometer is updated when the robot is considered to be immobile. The robot is considered to be immobile at times when variations in the measurements delivered by the gyrometer are below a threshold. When such a threshold is crossed, the robot is considered to be immobile. The bias of the gyrometer is then estimated by calculating a mean value of the signals delivered by the gyrometer while the robot is considered to be immobile. It is specified, in this document, that the threshold is determined either theoretically or experimentally.

An approach based on the detection of periods of immobility of the sensor is satisfactory, because it does not require other types of movement sensors. However, detection of a period of immobility requires a threshold and setting this threshold may pose a number of difficulties: when the threshold is too high, the sensor is considered to be immobile even though it may not be entirely so. The bias, although updated frequently, may be poorly estimated, and in particular overestimated, if the sensor is considered to be immobile even though it is still moving. When the threshold is too low, the bias is correctly estimated, because the threshold then corresponds to periods in which the sensor is sufficiently immobile. However, the bias cannot be updated frequently, and the measurements may be adversely affected because of variability in the bias.

The objective of the invention is to allow the bias of a movement sensor to be updated precisely and as often as possible, without recourse to other movement sensors.

### SUMMARY OF THE INVENTION

A first subject of the invention is a method for processing signals generated by a sensor, each signal being associated with a measurement time, the method including the following steps:
a) during an initialization phase, defining an initial dispersion threshold and optionally an initial bias, the latter possibly being zero;
b) acquiring a signal at a measurement time, there being associated with this measurement time:
   a bias determined in a preceding iteration or during the initialization;
   a dispersion threshold determined in a preceding iteration or during the initialization;
c) associating an analysis time period with the measurement time, and calculating a dispersion indicator representing a dispersion of the signals acquired over the analysis time period;
d) comparing the dispersion indicator with the dispersion threshold associated with the measurement time;
e) depending on the comparison of step d), either keeping the bias at an unchanged value or updating the bias;
f) subtracting the bias resulting from step e) from the signal acquired in step b); and
g) incrementing the measurement time and reiterating steps b) to f);
   wherein, in step e), the update of the bias also includes updating the dispersion threshold depending on the dispersion indicator calculated in step c), at said measurement time.

The iterations may be carried out at each measurement time, or every n measurement times, n being an integer higher than 1.

The sensor may in particular be a movement sensor, in which case the signals generated by the sensor are representative of a movement of said sensor over time.

According to an embodiment, in step e), the bias is updated when the dispersion indicator crosses the dispersion threshold.

According to an embodiment, in step e), in the update of the dispersion threshold, the latter is replaced by the dispersion indicator calculated, at the measurement time, in step c).

According to one embodiment, the initial bias is zero. In this embodiment, up to the first update of the bias, no bias is subtracted from the measured signals. According to another embodiment, the initial bias is set beforehand, for example during testing of the sensor or during a preceding use of the sensor.

According to one embodiment, when the bias is kept at an unchanged value, the dispersion threshold is updated, between two successive iterations, according to a variation function. Thus, in this embodiment, the value of the dispersion threshold may vary over time, and more particularly between two successive iterations.

According to one embodiment, the dispersion indicator calculated in step c) increases as the dispersion of the signals acquired over the analysis time period increases, in which case, in step e), the bias is updated when the dispersion indicator is lower than the dispersion threshold.

According to one embodiment, the dispersion indicator calculated in step c) decreases as the dispersion of the signals acquired over the analysis time period increases, in which case in step e), the bias is updated when the dispersion indicator is higher than the dispersion threshold.

According to one embodiment, in step d), the dispersion indicator is calculated depending on:
a moment of order higher than 1 of a distribution of the signals acquired over the analysis time period, the moment possibly being a central moment or a standardized moment;
or a deviation between a maximum value and a minimum value of the signals acquired over the analysis time period.

In step e), the update of the bias may comprise associating an estimation time period with the measurement time, the bias being updated depending on a value representative of the signals measured over said estimation time period. Step e) may then include estimating the mean value or the median value of the signals generated by the sensor over the estimation time period. The estimation time period may be identical to the analysis time period.

The sensor may in particular be a movement sensor, the signal generated by the sensor at each measurement time being representative of the movement of the sensor at said measurement time. The sensor may be a gyrometer or an accelerometer.

According to one embodiment, two successive iterations are carried out every n measurement times, n being an integer strictly higher than 1. According to this embodiment, in step g), the measurement time is incremented by n increments. Between two iterations, all or some of the measurement signals may then be stored in memory, in particular during the analysis time period and the estimation time period corresponding to the following iteration.

Another subject of the invention is a sensor able to deliver a signal at various measurement times, the sensor being connected to a processor configured to implement, at various measurement times, steps b) to g) of the method that is the first subject of the invention, after an initialization phase corresponding to step a) of said method. The sensor may in particular be a movement sensor able to generate, at each measurement time, a signal representative of a movement of the sensor at said measurement time. It may in particular be a gyrometer.

Other advantages and features will become more clearly apparent from the following description of particular embodiments of the invention, which embodiments are given by way of nonlimiting example, and shown in the figures listed below.

### BRIEF DESCRIPTION OF THE DRAWINGS

FIG. 1A shows an example of a device according to the invention.

FIG. 1B shows an illustrative example of the variation as a function of time of signals generated by a gyrometer.

FIG. 1C shows the variation in a dispersion indicator determined on the basis of the signals shown in FIG. 1B. FIG. 1C also shows various times at which the bias is updated, these times being defined according to a first embodiment.

FIG. 2A schematically shows the main steps of the first embodiment. FIG. 2B schematically shows the main steps of a second embodiment.

FIG. 3A corresponds to FIG. 1C. FIG. 3B shows the variation in a dispersion indicator determined on the basis of the signals shown in FIG. 1B. FIG. 3A shows various times at which the bias is updated, these times being defined according to the second embodiment.

### DETAILED DESCRIPTION OF THE ILLUSTRATED EMBODIMENTS

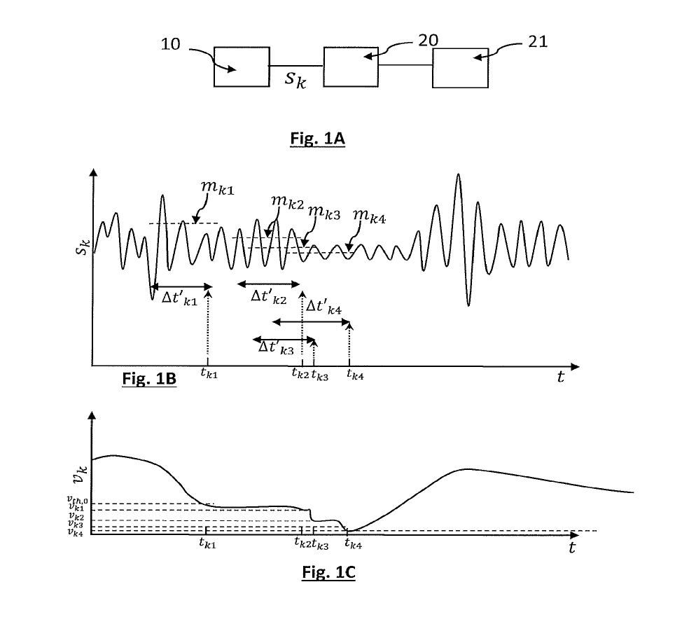

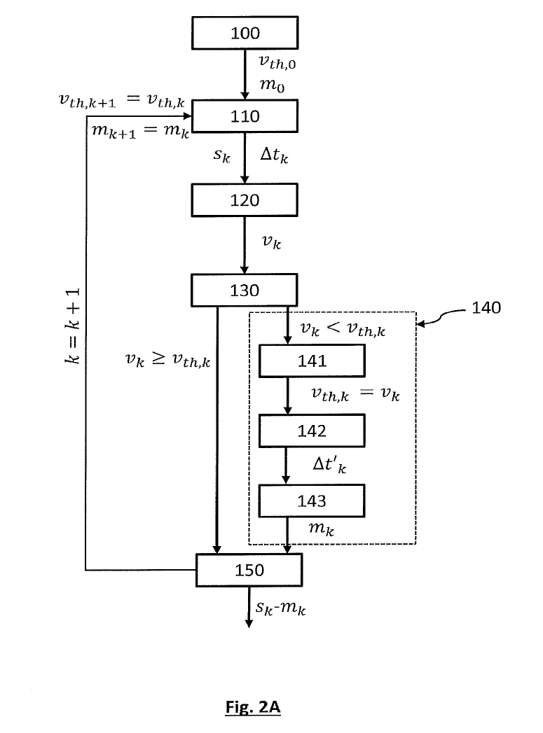

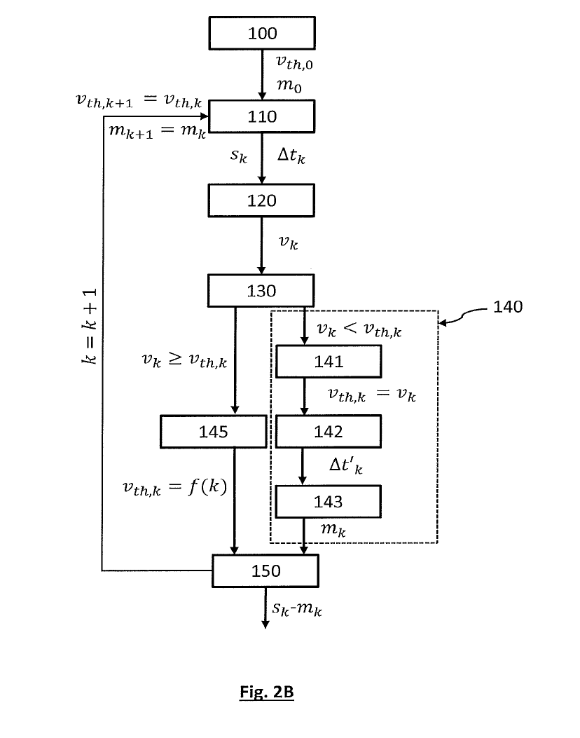

FIG. 1A shows an example of a device according to the invention. A gyrometer 10 generates signals sₖ at various measurement times tₖ. Each signal sₖ is representative of an angular velocity about an axis of rotation. The gyrometer may generate an angular velocity about various axes of rotation, for example three axes of rotation, in which case it simultaneously delivers, at each measurement time tₖ, an angular velocity about each axis of rotation.

In the following examples, an angular velocity about one axis of rotation is considered even though the method may be applied to a plurality of axes of rotation. In the latter case, the method may be applied to each axis of rotation independently.

The device includes a processor 20 configured to acquire the signals sₖ delivered by the gyrometer 10 and to implement the steps described below. The processor 20 is connected to a memory 21 containing instructions for implementing said steps.

FIG. 1B shows the variation as a function of time of signals sₖ generated, over time, by the gyrometer. They are discrete signals acquired at a sampling frequency, the latter for example being comprised between 10 and 200 Hz. Together, all of the acquired signals form the curve shown in FIG. 1B.

Beyond an initialization phase Δt₀ corresponding to the first acquired signals, it is possible to assign an analysis time period Δtₖ to each measured signal sₖ, and to calculate, for said period, an indicator, called the dispersion indicator vₖ. The dispersion indicator vₖ is representative of the dispersion of the signals measured over the analysis time period Δtₖ associated with the measurement time tₖ. The objective of the dispersion indicator is to detect times of immobility at which the sensor may be considered to be immobile. Just as in the prior art, it is at such times of immobility that the bias of the sensor may be estimated.

The analysis time period Δtₖ contains measurement times preceding a measurement time tₖ. For example, each analysis time period Δtₖ contains the times tₖ . . . t_{k-K} where k corresponds to the increment of the measurement time at which the signal sₖ is measured and K is a positive integer corresponding to the number of measurement times forming the analysis time period Δtₖ. K is preferably high enough to make it possible to estimate a dispersion indicator vₖ that is sufficiently representative of the dispersion of the measurement signals over the analysis time period Δtₖ. K naturally depends on the sampling frequency. When the latter is comprised between 10 and 200 Hz, K is preferably comprised between 5 and 50, and for example equal to 30. The analysis time period Δtₖ is typically between 100 ms and 5 s long, and preferably between 100 ms and 1 s long. This allows the dispersion of the measurement signals during the analysis time period to be estimated with sufficient precision, while also allowing sufficiently brief phases of immobility to be detected.

The dispersion indicator vₖ associated with a measurement time tₖ may be established on the basis of the variance σₖ² or the standard deviation σₖ of the signals sₖ measured during the analysis time period Δtₖ. More generally, the dispersion indicator vₖ corresponding to an analysis time period Δtₖ is established on the basis of a statistical indicator of a distribution formed by the signals sₖ measured during said analysis time period. The statistical indicator may be a moment of the distribution, in particular a moment mᵣ of order r strictly higher than 1 of the distribution. The dispersion indicator may for example be obtained from the second moment (standard deviation) or from the third moment (skewness) or from the fourth moment (kurtosis). The term moment encompasses a central moment or a standardized central moment.

The dispersion indicator vₖ may also be determined via a comparison between a maximum value maxₖ and a minimum value minₖ of the signals sₖ measured during an analysis time period Δtₖ. The comparison may take the form of a subtraction or a ratio.

In the following examples, the dispersion indicator vₖ associated with each measurement time tₖ (and with each measured signal sₖ) is the standard deviation of the signals measured during the analysis period Δtₖ associated with the measurement time tₖ. FIG. 1C schematically shows the variation as a function of time of the dispersion indicator vₖ based on the signals sₖ shown in FIG. 1B.

The main steps of a first embodiment of the invention will now be described with reference to FIG. 2A.

Step 100: Initialization.

In an initialization phase, for example corresponding to the first moments of use of the sensor 10, the bias of the sensor is initialized to an initial value of the bias m₀. The initial value of the bias may be zero or may be defined beforehand arbitrarily, for example on the basis of a bias stored in memory during a previous use of the sensor 10, or on the basis of tests carried out on the sensor in the factory.

The initialization also includes assigning an initial value to a dispersion threshold v_{th,0}. This value may be set, or result from a previous use of the sensor 10.

Following the initialization step, steps 110 to 150 are implemented iteratively, each iteration being assigned an iteration rank k. In the first iteration, k=1.

Step 110: acquisition of a signal sₖ generated by the gyrometer 10. The signal sₖ is acquired at a measurement time tₖ. With this measurement time tₖ is associated an analysis time period Δtₖ such as defined above. Provided that k<K, the analysis time period is defined between t_{k,k=1} and the measurement time tₖ.

Step 120: calculation of a dispersion indicator. An indicator vₖ of the dispersion of the signals s_{k-K} . . . sₖ measured in the analysis time period Δtₖ is calculated. This dispersion indicator corresponds to the measurement time tₖ. Provided that k<K, the dispersion indicator is either considered to be equal to an arbitrary value, or established in the analysis period defined in step 110. The signals s_{k-K} . . . sₖ are stored in a memory, until the dispersion indicator vₖ is calculated.

Step 130: comparison. The dispersion indicator vₖ corresponding to the measurement time tₖ is compared with the dispersion threshold v_{th,k}, called the current dispersion threshold, associated with the measurement time tₖ. In the first iteration (k=1), the dispersion threshold v_{th,k=1} corresponds to the initial dispersion threshold v_{th,0} defined in the initialization phase.

Depending on the comparison, either a step 140 of updating the bias and the dispersion threshold is triggered, or the step 150 of correcting the measured signal is passed to.

When the dispersion indicator vₖ increases as the dispersion of the signals in the analysis time period Δtₖ increases, this corresponding to the case shown in FIG. 2A, step 140 is triggered when the dispersion indicator is below the current dispersion threshold v_{th,k}. When the dispersion indicator vₖ decreases as the dispersion of the signals in the analysis time period Δtₖ increases, step 140 is triggered when the dispersion indicator is higher than the current dispersion threshold v_{th,k}.

Step 140: Update of the bias and of the dispersion threshold.

With each iteration is associated a bias mₖ, called the current bias, that is intended to be subtracted from the measured signal sₖ. In the first iteration (k=1), the bias mₖ₋₁ is the initial bias m₀ resulting from the initialization. Step 140 corresponds to an update of the bias to be considered. This step is implemented when the sensor is considered, on the basis of the comparison carried out in step 130, to be sufficiently immobile. The term sufficiently immobile describes the fact that the update is triggered when the sensor is considered to be more immobile than in the preceding update. It includes the following substeps:
Substep 141: update of the dispersion threshold: the current dispersion threshold v_{th,k} is replaced by the value of the dispersion indicator vₖ that was calculated in step 120.
Substep 142: definition of an estimation time period Δt′ₖ, so as to estimate the bias of the sensor. The estimation time period Δt′ₖ includes measurement times preceding the time tₖ at which the signal sₖ is obtained. For example, each estimation time period contains the times tₖ . . . t_{k-K′}, where tₖ is the measurement time of the signal sₖ and K′ is a positive integer corresponding to the number of measurement times forming the estimation time period Δt′ₖ. K′ is preferably comprised between 5 and 50, and is for example equal to 30. The estimation time period is defined in order to estimate a value of the bias depending on the signals sₖ . . . s_{k-K′}, measured during said period. The signals sₖ . . . s_{k-K′} are stored in memory until the dispersion threshold is updated. The estimation time period Δt′ₖ may be the same as the analysis time period Δtₖ.
Substep 143: update of the bias. It is a question of updating the current bias mₖ to be taken into account to correct the measured signal sₖ. The bias is updated depending on an indicator that is either the mean or median of the signals s_{k-K′} . . . sₖ measured in the estimation time period Δt′ₖ. In this example, the bias is updated to reflect the mean μₖ of the signals measured during the estimation time period Δt′ₖ.

Step 150: Correction of the measured signal

In this step, the measured signal sₖ is corrected depending on the current bias mₖ, in particular via a subtraction sₖ−mₖ. Depending on the comparison carried out in step 130, the current bias mₖ results either from a preceding iteration or from the initialization phase, or from the update carried out in step 140. When, in the initialization, the value of the initial bias is zero, or when no initial bias value is defined, no correction of the bias is carried out in step 150, until a first update of the bias.

The iteration rank k is incremented and steps 110 to 150 are reiterated. The iteration may take place at each measurement time, in which case the iteration rank is incremented by 1 such that, in the following iteration, mₖ₊₁=mₖ and v_{th,k+1}=v_{th,k}. The iteration may also occur every n measurement times, n being an integer strictly higher than 1, such that, between two successive iterations, the sensor measures n−1 measurement signals. In this case, in mₖ₊ₙ=mₖ and v_{th,k+n}=v_{th,k}. All or some of the signals measured between two successive iterations may be stored in memory, in particular the signals measured during the estimation and analysis time periods taken into account in each iteration.

FIGS. 1B and 1C allow the effect of the method to the seen. These figures show four successive updates of the bias affecting the measurements. Following initialization, the initial bias m₀ is considered to be zero and the initial dispersion threshold is v_{th,0}. At a time tₖ₁, the dispersion indicator vₖ₁ crosses the initial threshold v_{th,0}. A first estimation mₖ₁ of the bias is carried out while considering an estimation time period Δt′ₖ₁. From this time, i.e. at the time t_{k1.}, the current dispersion threshold v_{th,k} is replaced by the dispersion indicator vₖ₁.

At a time tₖ₂, the dispersion indicator vₖ₂ crosses the dispersion threshold v_{th,k2}=vₖ₁. A second estimation mₖ₂ of the bias is carried out considering an estimation time period Δt′ₖ₂. From this time, i.e. at the time tₖ₂, the dispersion threshold v_{th,k} is replaced by the dispersion indicator vₖ₂. At a time tₖ₃, the dispersion indicator vₖ₃ crosses the dispersion threshold v_{th,k3}=vₖ₂. A third estimation mₖ₃ of the bias is carried out considering an estimation time period Δt′ₖ₃. From this time, i.e. at the time tₖ₃, the dispersion threshold v_{th,k} is replaced by the dispersion indicator vₖ₃. According to the same principles, a new update mₖ₄ of the bias and of the dispersion threshold v_{th,k4}=v₃ is carried out at the time tₖ₄. From this time, i.e. at the time tₖ₄, the dispersion threshold v_{th,k} is replaced by the dispersion indicator vₖ₄.

An important aspect of the method is the replacement of the dispersion threshold v_{th,k} by the dispersion indicator vₖ associated with the update time tₖ. In the example considered, in which the update is carried out when the dispersion indicator is below the dispersion threshold, this leads to a gradual decrease in the value of the dispersion threshold, such that the dispersion threshold after an update is necessarily lower than the dispersion threshold before the update. This is shown in FIG. 1C, in which it may be seen that:

v_{th,k0}>vₖ₁>vₖ₂>vₖ₃>vₖ₄.

When the dispersion indicator increases as the dispersion decreases (for example if the dispersion indicator considered is equal to the inverse of the standard deviation), step 140 is carried out when the dispersion indicator exceeds the dispersion threshold. In this case, the method tends to gradually increase the value of the dispersion threshold.

Generally, the method tends to attribute, to each bias update, a relevance indicator, the latter corresponding to the simultaneously updated dispersion threshold. A bias is updated only if conditions more propitious to bias renewal present themselves, such conditions being expressed by a dispersion indicator representative of a dispersion of the measurement signals that is lower than in the preceding update.

In the example shown in FIGS. 1B and 1C, when tₖ>tₖ₄, the dispersion indicator vₖ increases. The dispersion threshold being low (v_{th,k}=vₖ₄), no other update is then carried out. Such a situation may lead to a substantial amount of time passing between two successive updates of the bias. Thus, according to a second embodiment, the dispersion threshold may vary over time, so as to gradually modulate the condition of update of the bias. Thus, the dispersion threshold does not have a set value, as in the first embodiment, but gradually varies, between two successive time increments, according to a time-dependent variation function ƒ(tₖ). For example, the dispersion threshold may be constant for a few hundred or thousand increments k, then may gradually increase so as to permit a new update. This allows the requirement that the measured signals be stable before an update is carried out to be relaxed. FIG. 2B illustrates the main steps of such an embodiment.

Steps referenced with the same numbers are identical to those described above. The method includes a step 145 in which the dispersion threshold varies in a way dependent on the variation function ƒ. Thus, following step 140:
either the bias is updated, and likewise the dispersion threshold (steps 141 to 143);
or the bias is not updated, in which case step 145 allows the value of the dispersion threshold to be adjusted.

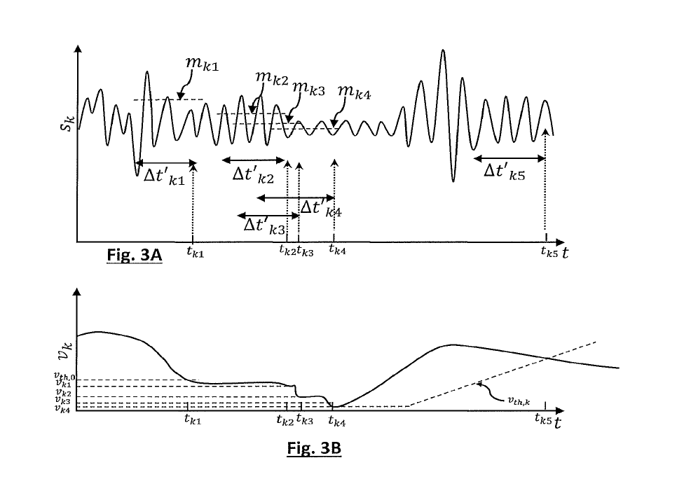

FIGS. 3A and 3B illustrate such an embodiment. FIG. 3A corresponds to a variation in the measured signal that is similar to the variation shown in FIG. 1B. FIG. 3B shows the variation as a function of time of the dispersion indicator, analogously to FIG. 1C. The bias and the dispersion threshold are updated as detailed above, with reference to FIG. 1C. Following the time tₖ₄, the dispersion threshold v_{th,k} remains constant and equal to vₖ₄ for a short while, then gradually increases linearly. This allows an update to be carried out at a time tₖ₅, when the dispersion indicator vₖ₅ is such that vₖ₅=v_{th,k5}=ƒ(tₖ₅). Recourse to such a gradual adjustment of the dispersion threshold makes it possible to prevent two successive updates of the bias from being too far apart in time. Account is thus better taken of the variability in the bias over time.

Although described with reference to a gyrometer, the invention will also possibly be applied to other sensors requiring a regular update of a bias, whether they be movement sensors or other types of sensor. In the field of movement sensors, the invention will possibly be applied to a gyrometer, as described in the above example, but also to magnetometers, in particular when they are configured to deliver a reference measurement when they are immobile, the reference measurement being known. In the examples described above, the reference measurement is equal to zero when the gyrometer is immobile. The method may be applied to a vertical axis of an accelerometer, the reference value being gravity. In this case, in a period of immobility of the sensor, corresponding to the estimation period described above, the mean of the measurements corresponds to the sum of gravity and of the bias. The bias is therefore obtained by subtracting gravity from the mean of the measurements during the estimation period.

The invention will possibly be applied to movement sensors with which portable devices (for example smartphones, watches or connected objects) are equipped.

1. A method for processing signals generated by a sensor, each signal being associated with a measurement time, the method comprising:
a) during an initialization phase, defining an initial dispersion threshold and an initial bias, the latter possibly being zero;
b) acquiring a signal at a measurement time, there being associated with this measurement time:
a bias determined in a preceding iteration or during the initialization;
a dispersion threshold determined in a preceding iteration or during the initialization;
c) associating an analysis time period with the measurement time, and calculating a dispersion indicator representing a dispersion of the signals acquired over the analysis time period;
d) comparing the dispersion indicator calculated in c) with the dispersion threshold associated with the measurement time;
e) depending on the comparison of d), either keeping the bias associated with the measurement time at an unchanged value or updating the bias, the update of the bias also including updating the dispersion threshold depending on the dispersion indicator calculated in c);
f) subtracting the bias resulting from e) from the signal acquired in b); and
g) incrementing the measurement time and reiterating b) to f);
wherein in step e), when the bias is kept at an unchanged value, the dispersion threshold is updated, between two successive iterations of b) to f), according to a variation function.

2. The method of claim 1, wherein, in e), the bias is updated when the dispersion indicator crosses the dispersion threshold.

3. The method of claim 1, wherein, in e), in the update of the dispersion threshold, the latter is replaced by the dispersion indicator calculated, at the measurement time, in c).

4. The method of claim 1, wherein the dispersion indicator calculated in c) increases as the dispersion of the signals acquired over the analysis time period increases, in which case, in step e), the bias is updated when the dispersion indicator is lower than the dispersion threshold.

5. The method of claim 1, wherein the dispersion indicator calculated in c) decreases as the dispersion of the signals acquired over the analysis time period increases, in which case in e), the bias is updated when the dispersion indicator is higher than the dispersion threshold.

6. The method of claim 1, wherein, in d), the dispersion indicator is calculated depending on:
a moment of order higher than 1 of a distribution of the signals acquired over the analysis time period, the moment possibly being a central moment or a standardized moment;
or a deviation between a maximum value and a minimum value of the signals acquired over the analysis time period.

7. The method of claim 1, wherein, in e), the update of the bias comprises associating an estimation time period with the measurement time, the bias being updated depending on a value representative of the signals measured over the estimation time period.

8. The method of claim 7, wherein e) includes estimating the mean value or the median value of the signals generated by the sensor over the estimation time period.

9. The method of claim 7, wherein the analysis time period and the estimation time period are the same.

10. The method of claim 1, wherein the sensor is a movement sensor, the signal generated by the sensor at each measurement time being representative of a movement of the sensor at the measurement time.

11. The method of claim 10, wherein the sensor is a gyrometer.

12. The method of claim 1, wherein two successive iterations are carried out every n measurement times, n being an integer strictly higher than 1.

13. A sensor configured to deliver a signal at various measurement times, the sensor being connected to a processor configured to implement, at various measurement times, steps b) to g) of the method as claimed in claim 1, after an initialization phase corresponding to step a) of the method.

14. The sensor of claim 13, the sensor being a movement sensor able to generate, at each measurement time, a signal representative of a movement of the sensor at the measurement time.
